(19) United States
(12) Patent Application Publication
(10) Pub. No.: US 2008/0116799 A1
(43) Pub. Date: May 22, 2008

(54) PLASMA DISPLAY PANEL

(76) Inventors: Tae-Seung Cho, Suwon-si (KR); Won-Ju Yi, Suwon-si (KR); Kyoung-Doo Kang, Suwon-si (KR); Young-Do Choi, Suwon-si (KR); Jae-Ik Kwon, Suwon-si (KR); Yong-Shik Hwang, Suwon-si (KR); Byoung-Min Chun, Suwon-si (KR); Seok-Gyun Woo, Suwon-si (KR); Hyea-Jin Park, Suwon-si (KR)

Correspondence Address: CHRISTIE, PARKER & HALE, LLP, PO BOX 7068, PASADENA, CA, 91109-7068, US

(21) Appl. No.: 11/938,015

(22) Filed: Nov. 9, 2007

(30) Foreign Application Priority Data
Nov. 22, 2006 (KR) 10-2006-0116036

(51) Int. Cl. H01J 17/49

(52) U.S. Cl. 313/582

(57) ABSTRACT

A plasma display panel includes a pair of substrates having a first substrate where an image is displayed and a second substrate. A barrier rib structure separates the substrates and has discharge cells within the barrier rib structure. Discharge electrode pairs are in the barrier rib structure, at least one of the discharge electrode pairs surrounding a discharge cell. A ferroelectric layer is on surfaces of the barrier rib structure forming the discharge cells. A phosphor layer is in each of the discharge cells.

### CROSS-REFERENCE TO RELATED PATENT APPLICATION

This application claims priority to and the benefit of Korean Patent Application No. 10-2006-0116036, filed on Nov. 22, 2006, in the Korean Intellectual Property Office, the entire content of which is incorporated herein by reference.

### BACKGROUND OF THE INVENTION

1. Field of the Invention

The present invention relates to a plasma display panel (PDP), and more particularly, to a plasma display panel having increased light emission efficiency.

2. Description of the Related Art

A PDP is a flat panel display device that displays desired images using visible light emitted from phosphor layers which are excited by ultraviolet rays generated during gas discharge. The gas discharge is generated by a direct or alternating current voltage applied to a plurality of discharge electrodes formed on a plurality of substrates between which a discharge gas is filled.

Typically, PDPs are classified into direct current (DC) PDPs and alternating current (AC) PDPs according to the type of driving voltage applied to discharge cells, i.e. according to the discharge type. PDPs can further be classified into facing discharge PDPs and surface discharge PDPs according to the arrangement of electrodes.

FIG. 1 is a cut-away perspective view of a conventional three-electrode surface discharge type plasma display panel 100. The conventional three-electrode surface discharge type plasma display panel 100 includes a first substrate 101 and a second substrate 102 facing the first substrate 101. Sustain discharge electrode pairs 103 each have an X electrode 104 and a Y electrode 105 formed on an inner surface of the first substrate 101. A first dielectric layer 106 covers the sustain discharge electrode pairs 103. A protective film layer 107 is formed on the surface of the first dielectric layer 106. A plurality of address electrodes 108 are formed on the inner surface of the second substrate 102 and perpendicularly cross the sustain discharge electrode pairs 103. A second dielectric layer 109 covers the address electrodes 108. A barrier rib structure 110 is formed between the first and second substrate 101, 102 to define a plurality of discharge cells. Red, green, and blue phosphor layers 111 are formed in respective discharge cells. An inner space formed by the combination of the first substrate 101 and the second substrate 102 is a discharge space, and is filled with a discharge gas.

In the conventional three-electrode surface discharge type plasma display panel 100 having the above structure, when an electric signal is applied to the Y electrode 105 and the address electrodes 108, discharge cells for emitting light are selected. Afterwards, when electric signals are alternately applied to the X electrode 104 and the Y electrode 105, a surface discharge is generated from the surface of the first substrate 101. The surface discharge generates ultraviolet rays, which excite phosphor materials of the phosphor layers 111 coated on the selected discharge cells to emit visible light, and thus, a stationary or moving image can be displayed.

However, the conventional three-electrode surface discharge type plasma display panel 100 has the following disadvantages.

First, the sustain discharge electrode pairs 103, the first dielectric layer 106, and the protective film layer 107 are sequentially formed on the inner surface of the first substrate 101. Therefore, the transmittance of visible light generated in the discharge cells cannot reach 60%. Accordingly, the conventional three-electrode surface discharge type plasma display panel 100 cannot attain high efficiency.

Second, when the conventional three-electrode surface discharge type plasma display panel 100 is operated for an extended period of time, a permanent latent image forms, since discharge expands towards the phosphor layer 111, and as a result, charged particles of a discharge gas are sputtered to the phosphor layer 111 by an electric field.

Third, discharge expands outwards from a discharge gap between the X electrode 104 and the Y electrode 105. However, the discharge expands along the flat surface of the first substrate 101 in the conventional three-electrode surface discharge type plasma display panel 100. Therefore, the space utilization of the discharge cells is low.

Fourth, when a discharge gas containing a high concentration of Xe gas, at 10 vol. % or above, is filled in the discharge cells, charged particles and excited materials increase due to the ionization of atoms and an excitation reaction, and as a result, brightness and discharge efficiency can increase. However, the high concentration Xe gas demands a high initial discharge firing voltage.

### SUMMARY OF THE INVENTION

In accordance with the present invention a plasma display panel is provided having increased light emission efficiency due to a ferroelectric layer formed on the surface of a barrier rib structure that, together with a pair of substrates, form discharge cells. The plasma display panel can effectively control the generation of plasma due to the ferroelectric layer.

According to an aspect of the present invention, there is provided a plasma display panel having a pair of substrates including a first substrate where an image is displayed and a second substrate. A barrier rib structure separates the substrates and has a plurality of discharge cells within the barrier rib structure. A plurality of discharge electrode pairs are in the barrier rib structure, at least one of the discharge electrode pairs surrounding a discharge cell of the plurality of discharge cells. A ferroelectric layer is formed on surfaces of the barrier rib structure forming the discharge cells. A phosphor layer is formed in each of the discharge cells.

The ferroelectric layer may be formed around an inner surface of the barrier rib structure that forms the discharge cells.

The ferroelectric layer may be formed on a region of the barrier rib structure corresponding to the region where the discharge electrode pairs are formed.

The ferroelectric layer may be a solid solution or mixed phase of ABO₃ perovskite or A(B_{2/3}C_{1/3})O₃ composite perovskite formed of one part selected from a first group consisting of lead, lanthanum, and samarium, one part selected from a second group consisting of titanium, zirconium, niobium, tantalum, manganese, and hafnium, and one part selected from a third group consisting of magnesium, nickel, zinc, iron, and cobalt.

### BRIEF DESCRIPTION OF THE DRAWINGS

FIG. 1 is a partially exploded cutaway perspective view of a conventional three-electrode surface discharge type plasma display panel.

FIG. 2 is a partially exploded cutaway perspective view of a plasma display panel according to an embodiment of the present invention.

FIG. 3 is a cross-sectional view taken along line I-I of FIG. 2.

FIG. 4 is a perspective view illustrating the arrangement of discharge electrodes of the plasma display panel of FIG. 2.

FIG. 5 is a cross-sectional view of a plasma display panel according to another embodiment of the present invention.

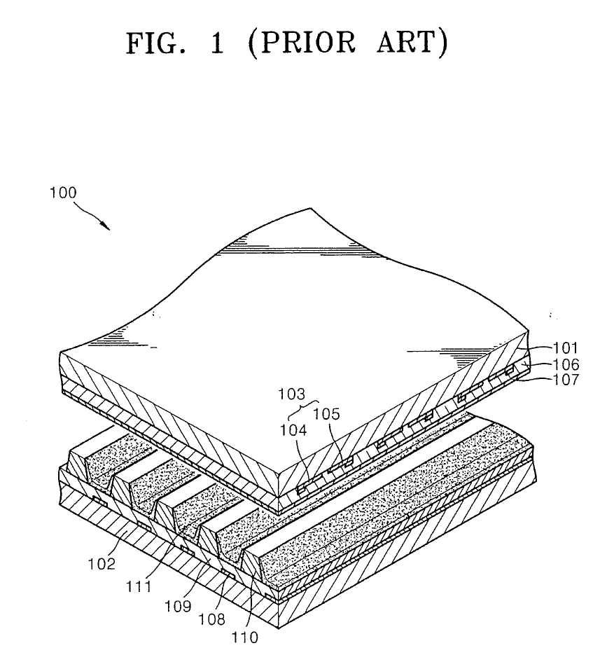

### DETAILED DESCRIPTION

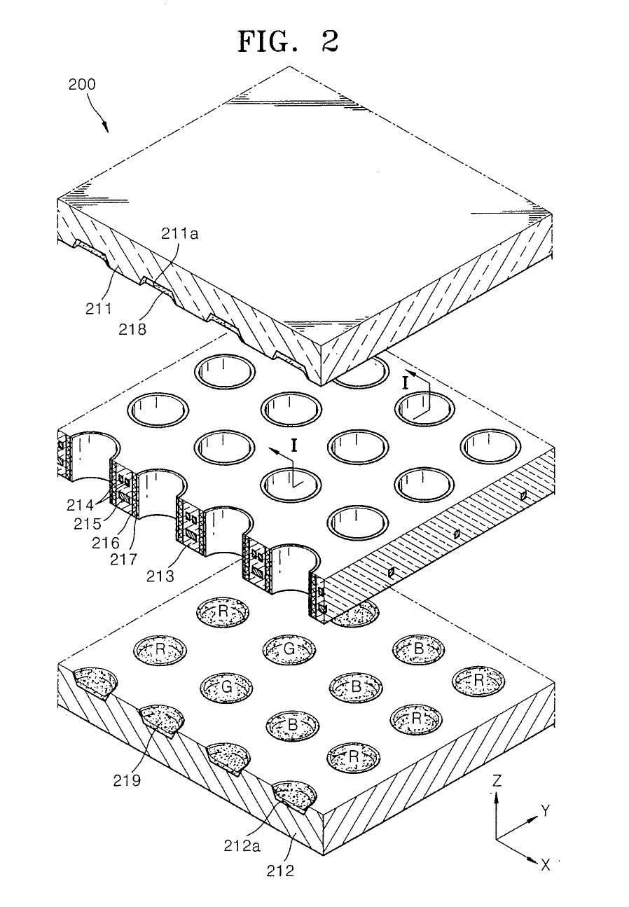

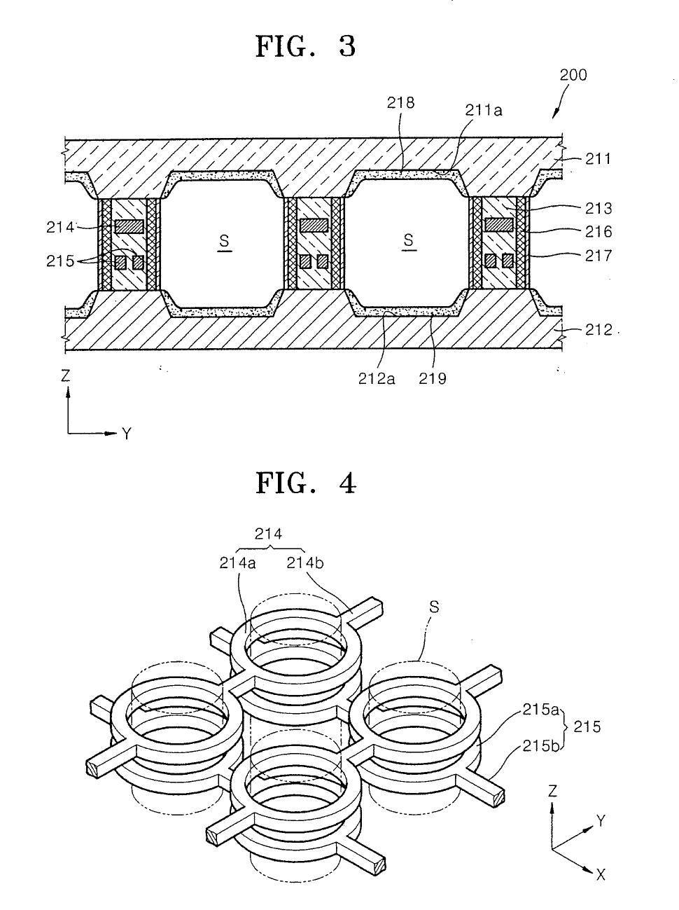

Referring to FIGS. 2 through 4, a plasma display apparatus 200 includes a first substrate 211 and a second substrate 212 parallel to the first substrate 211. Frit glass (not shown) is coated on the edges of the inner surfaces of the first substrate 211 and the second substrate 212 facing each other, to seal a discharge space.

The first substrate 211 is formed of glass having a high optical transmittance. Alternatively, the first substrate 211 may be colored or semi-transparent to increase bright room contrast by reducing reflection brightness.

A barrier rib structure 213 is located between the first substrate 211 and the second substrate 212 to define discharge cells S and prevent electrical and optical cross-talk between the discharge cells S.

A plurality of discharge electrode pairs 214, 215 are buried in the barrier rib structure 213 on different planes from each other. The barrier rib structure 213 may be formed of a high dielectric material that contains, for example, ZnO—B₂O₃—Bi₂O₃, PbO—B₂O₃—SiO₂, PbO, or Bi₂O₃ as a main component. The barrier rib structure 213 can prevent direct connection between the first discharge electrodes 214 and the adjacent second discharge electrodes 215, can prevent the discharge electrode pairs 214, 215 from being damaged by positive ions or electrons, and can accumulate wall charges by inducing charges.

In the present embodiment, the barrier rib structure 213 defines the discharge cells S with circular shaped horizontal cross-sections, but the present invention is not limited thereto. That is, the barrier rib structure 213 can have various shapes as long as the barrier rib structure 213 defines a plurality of discharge cells S. For example, the horizontal cross-sections of the discharge cells S may be a polygonal shape, such as triangular, rectangular, or pentagonal shapes, or a non-circular shape. Also, the barrier rib structure 213 may be formed to define the discharge cells S with a delta, waffle, or meander form.

The first discharge electrodes 214 extend surrounding respective discharge cells S arranged in a Y direction of the plasma display panel 200. Each of the first discharge electrodes 214 includes a first discharge unit 214a that surrounds the discharge cells S in an open loop or a closed loop, and a first connection unit 214b that electrically connects the first discharge units 214a.

In FIG. 4, the first discharge unit 214a has a circular shape loop, but the present invention is not limited thereto. That is, the first discharge unit 214a can have various shapes such as an open loop or closed loop of a rectangular or hexagonal shape. However, the first discharge unit 214a would have substantially the same shape as the horizontal cross-sections of the discharge cells S.

The second discharge electrodes 215 extend surrounding respective discharge cells S arranged along an X direction of the plasma display panel 200, crossing the first discharge electrodes 214. The second discharge electrodes 215 are separated from the first discharge electrodes 214 in the barrier rib structure 213 in a Z direction, perpendicular to the first discharge electrodes 214.

Each of the second discharge electrodes 215 includes a second discharge unit 215a that surrounds the discharge cells S and a second connection unit 215b that electrically connects the second discharge units 215a.

In FIG. 4, the second discharge units 215a have a circular shape loop, but the present invention is not limited thereto. That is, the second discharge units 215a can have various shapes such as an open loop or closed loop of a rectangular or hexagonal shape. However, the second discharge units 215a would have substantially the same shape as the horizontal cross-sections of the discharge cells S.

Since the first discharge electrode 214 and the second discharge electrode 215 are not disposed in locations such as an inner surface of the first substrate 211 that directly reduce transmittance of visible light, the first discharge electrode 214 and the second discharge electrode 215 may be formed of an opaque metal having high conductivity, such as Al or Cu.

The plasma display panel 200 has a two-electrode structure comprising the first discharge electrode 214 and the second discharge electrode 215. One of the first and second discharge electrodes 214, 215 functions as scanning and sustain electrodes, and the other functions as address and sustain electrodes.

The manufacture of the barrier rib structure 213 using dielectric sheets is convenient for the manufacturing process. That is, the barrier rib structure 213 is formed such that after a raw material for forming the barrier rib structure 213 and a raw material for forming the discharge electrodes 214, 215 are repeatedly coated on a base film, the resultant product is dried and annealed. Afterwards, dielectric sheets are manufactured by forming openings in regions corresponding to the discharge cells S using punching or etching. The dielectric sheets detached from the base films are located between the first substrate 211 and the second substrate 212. As a result, the barrier rib structure 213 in which the first discharge electrode 214 and the second discharge electrode 215 are buried in different planes is manufactured.

A ferroelectric layer 216 is formed on sidewalls of the barrier rib structure 213. The ferroelectric layer 216 is formed along inner walls of the barrier rib structure 213 that form the discharge cells S. The first and second discharge electrodes 214, 215 surround the discharge cells S. Thus, the ferroelectric layer 216 may be formed on the barrier rib structure 213 including a front region of the barrier rib structure 213 that corresponds to the region where the first and second discharge electrodes 214, 215 are formed. Accordingly, the horizontal cross-section of the ferroelectric layer 216 has a circular shape, and the ferroelectric layer 216 has substantially the same height as the barrier rib structure 213 in the Z direction of the plasma display panel 200.

In order to emit electrons at a low voltage, the ferroelectric layer 216 includes a solid solution or mixed phase of an ABO₃ perovskite or A(B_{2/3}C_{1/3})O₃ composite perovskite formed of one part selected from a first group consisting of lead, lanthanum, and samarium, one part selected from a second group consisting of titanium, zirconium, niobium, tantalum, manganese, and hafnium, and one part selected from a third group consisting of magnesium, nickel, zinc, iron, and cobalt.

A protective film layer 217 may be formed on the front surface of the ferroelectric layer 216. The protective film layer 217 prevents the barrier rib structure 213 and the first and second discharge electrodes 214, 215 from being damaged by sputtering of plasma particles, and at the same time, reduces a discharge voltage by emitting secondary electrons. The protective film layer 217 may be formed of MgO.

The second substrate 212 seals a discharge gas filled in the discharge cells S by combining with the first substrate 211 and the sheet shaped barrier rib structure 213 located between the first and second substrates 211, 212.

The second substrate 212 may be manufactured in one unit with the barrier rib structure 213 using the same annealing process for manufacturing the barrier rib structure 213, or may be manufactured by a separate annealing process from that for manufacturing the barrier rib structure 213, and may be combined with the first substrate 211 during a sealing process.

Also, a discharge gas such as Ne gas, Xe gas, or a mixture of Ne gas and Xe gas is filled and sealed in the discharge cells S. In the present embodiment, a discharge surface is increased, and thus a discharge region can be increased. Accordingly, the amount of plasma increases, thereby enabling low voltage driving of the plasma display panel 200. Therefore, although a high concentration of Xe gas is used as the discharge gas, low voltage driving is possible, thereby greatly increasing light emission efficiency.

First grooves 212a having a predetermined depth are formed in regions of the second substrate 212 corresponding to the discharge cells S. The first grooves 212a have a horizontal cross-section of a circular shape. The deeper the first groove 212a, the more the discharge region can be expanded.

A first phosphor layer 219 that generates visible light by ultraviolet rays is formed in each of the first grooves 212a. The first phosphor layer 219 includes a component that generates visible light by receiving ultraviolet rays. A phosphor layer formed in red light emitting cells includes a phosphor material such as Y(V,P)O₄:Eu. A phosphor layer formed in green light emitting cells includes a phosphor material such as Zn₂SiO₄:Mn or YBO₃:Tb. A phosphor layer formed in blue light emitting cells includes a phosphor material such as BAM:Eu.

The first substrate 211 may further include a plurality of second grooves 211a having a predetermined depth in regions corresponding to each of the discharge cells S. The second grooves 211a are independently formed in the discharge cells S in the same manner as the first grooves 212a. A second phosphor layer 218 is formed in each of the second grooves 211a. The second phosphor layer 218 is formed of substantially the same material as the first phosphor layer 219.

A method of operating the plasma display panel 200 having the above structure will now be described.

First, an address discharge is generated between the first discharge electrode 214 and the second discharge electrode 215 to select discharge cells S where sustain discharge is to be generated. Afterwards, when a sustain discharge voltage, which is an alternating current, is applied between the first and second discharge electrodes 214, 215, a sustain discharge is generated between the first and second discharge electrodes 214, 215.

The sustain discharge excites a discharge gas. When the energy level of the excited discharge gas falls, vacuum ultraviolet rays are generated. The vacuum ultraviolet rays simultaneously excite the first phosphor layer 219 and the second phosphor layer 218. When the energy levels of the first phosphor layer 219 and the second phosphor layer 218 fall, visible light is generated to form an image.

At this point, since the ferroelectric layer 216 is formed on the front wall of the barrier rib structure 213 that contacts the discharge cell S, electrons are emitted from the surface of the ferroelectric layer 216, increasing the electron density of the plasma. Thus, the efficiency of generating vacuum ultraviolet rays increases.

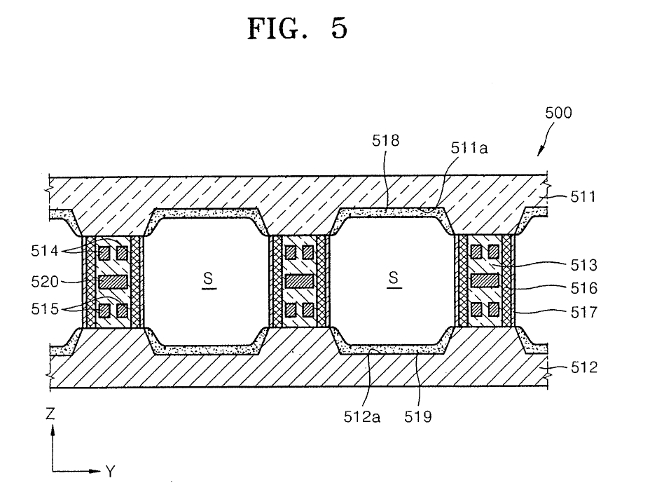

FIG. 5 is a cross-sectional view of a plasma display panel 500 according to another embodiment of the present invention.

The plasma display panel 500 includes a first substrate 511 and a second substrate 512 facing the first substrate 511. A barrier rib structure 513 formed of dielectric sheets is formed between the first and second substrates 511, 512.

A plurality of first, second and third discharge electrodes 514, 515, 520 are buried in the barrier rib structure 513. In FIG. 5, the barrier rib structure 513 defines discharge cells S having a horizontal cross-section of a circular shape, but the present invention is not limited thereto.

The first, second and third discharge electrodes 514, 515, 520 surround the discharge cells S and are insulated from each other. The first discharge electrodes 514 are relatively closer to the first substrate 511. The second discharge electrodes 515 are relatively closer to the second substrate 512. The third discharge electrode 520 is located between the first and second discharge electrodes 514, 515.

The first discharge electrodes 514 extend to surround adjacent discharge cells S located in an X direction of the plasma display panel 500. The second discharge electrodes 515 extend to surround the discharge cells S in the same direction as the first discharge electrode 514. The third discharge electrodes 520 extend in a direction crossing the extending direction of the second discharge electrodes 515.

The first discharge electrodes 514 and the second discharge electrodes 515 correspond to an X electrode and a Y electrode that generate sustain discharge. The third discharge electrodes 520 correspond to address electrodes extending in a direction crossing the second discharge electrodes 515. However, the number or shape of the discharge electrodes and the method of applying a voltage to the discharge electrodes are not limited thereto.

For example, besides the case that the plurality of discharge electrodes are located on different planes in the barrier rib structure 513, the discharge electrodes may be located in regions facing each other with respect to the center of each of the discharge cells S, or may be located on the same plane in the barrier rib structure 513.

A ferroelectric layer 516 is formed on an inner wall of the barrier rib structure 513. The ferroelectric layer 516 is formed around the barrier rib structure 513 that form the discharge cells S. The ferroelectric layer 516 may include a front portion of the barrier rib structure 513 corresponding to the region of the barrier rib structure 513 where the first, second and third discharge electrodes 514, 515, 520 are disposed.

A protective film layer 517 may be formed on the surface of the ferroelectric layer 516.

First grooves 512a having a predetermined depth are formed in regions of the second substrate 512 corresponding to the discharge cells. A first phosphor layer 519 is formed in each of the first grooves 512a. A plurality of second grooves 511a are formed on the inner surface of the first substrate 511, and a second phosphor layer 518 is formed in each of the second grooves 511a.

Accordingly, the plasma display panel 500 has plasma having a high electron density due to electron emission from the surface of the ferroelectric layer 516 when a sustain discharge is generated

As described above, a plasma display panel according to the present invention includes a ferroelectric layer on the outer surface of a barrier rib structure. Thus, the plasma display panel can reduce a discharge voltage and increase light emission efficiency by efficiently controlling the generation of plasma using the electron emission characteristics of the ferroelectric layer.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A plasma display panel comprising:
a pair of substrates having a first substrate for displaying an image and a second substrate;
a barrier rib structure separating the pair of substrates and having a plurality of discharge cells within the barrier rib structure;
a plurality of discharge electrode pairs in the barrier rib structure, at least one of the discharge electrode pairs surrounding a discharge cell of the plurality of discharge cells;
a ferroelectric layer on surfaces of the barrier rib structure forming the discharge cells; and
a phosphor layer in each of the discharge cells.

2. The plasma display panel of claim 1, wherein the ferroelectric layer is formed along an inner surface of the barrier rib structure that contacts the discharge cell.

3. The plasma display panel of claim 2, wherein the ferroelectric layer is adjacent to the discharge electrode pairs.

4. The plasma display panel of claim 3, wherein ferroelectric layer has a same height as the barrier rib structure.

5. The plasma display panel of claim 1, wherein the ferroelectric layer comprises a solid solution or mixed phase of ABO₃ perovskite or A(B_{2/3}C_{1/3})O₃ composite perovskite formed of one part selected from a first group consisting of lead, lanthanum, and samarium, one part selected from a second group consisting of titanium, zirconium, niobium, tantalum, manganese, and hafnium, and part one selected from a third group consisting of magnesium, nickel, zinc, iron, and cobalt.

6. The plasma display panel of claim 1, wherein the barrier rib structure is formed of dielectric sheets.

7. The plasma display panel of claim 1, wherein the discharge electrode pairs comprise a first discharge electrode and a second discharge electrode extending in a direction crossing the first discharge electrodes.

8. The plasma display panel of claim 7, wherein the first discharge electrode and the second discharge electrode are on different planes from each other.

9. The plasma display panel of claim 1, wherein the discharge electrode pairs comprise:
first discharge electrodes;
second discharge electrodes extending in a same direction as the first discharge electrodes for generating sustain discharge; and
third discharge electrodes for generating address discharge together with the second discharge electrodes.

10. The plasma display panel of claim 1, wherein the discharge electrode pairs extend in different directions from each other while surrounding the discharge cells.

11. The plasma display panel of claim 1, further comprising a protective film layer on the ferroelectric layer.

12. The plasma display panel of claim 1, further comprising:
first grooves having a first groove depth in regions of the second substrate within the discharge cells, and
a first phosphor layer in each of the first grooves.

13. The plasma display panel of claim 12, further comprising:
second grooves having a second groove depth in regions of the first substrate within the discharge cells, and
a second phosphor layer in each of the second grooves for emitting a same color as the first phosphor layer.
